(19) United States
(12) Patent Application Publication
(10) Pub. No.: US 2023/0335093 A1
(43) Pub. Date: Oct. 19, 2023

(54) PEDAL DEVICE AND ELECTRONIC KEYBOARD INSTRUMENT

(71) Applicant: CASIO COMPUTER CO., LTD., Tokyo (JP)

(72) Inventor: Hiroshi IKEMOTO, Tokyo (JP)

(73) Assignee: CASIO COMPUTER CO., LTD., Tokyo (JP)

(21) Appl. No.: 18/297,918

(22) Filed: Apr. 10, 2023

(30) Foreign Application Priority Data
Apr. 14, 2022 (JP) 2022-066718

(51) Int. Cl. G10H 1/34

(52) U.S. Cl. CPC G10H 1/348; G10H 2220/221; G10H 2220/265

(57) ABSTRACT

A pedal device has a pedal case including an opening portion, a base member on which the pedal case is provided, a pedal projecting outwards of the pedal case via the opening portion and provided rotatably by a rotational shaft supported by a bearing portion provided on the base member, and a pedal leg portion provided on the base member, including a setting member provided in such a manner as to be brought into abutment with a setting surface, and projecting outwards of the pedal case on a side where the pedal projects.

### CROSS-REFERENCE TO RELATED APPLICATION

This patent application is based upon and claims the benefit of priority under 35 USC 119 of Japanese Patent Application No. 2022-066718 filed on Apr. 14, 2022, the entire disclosure of which, including the specification, claims, drawings and abstract, is incorporated herein by reference in its entirety.

### BACKGROUND

### Technical Field

The present disclosure relates to a pedal device and an electronic keyboard instrument.

### Description of the Related Art

There have conventionally been disclosed musical instruments such as a piano and an electronic keyboard instrument which include a pedal device for imparting a damper effect to sounds produced by such a musical instrument and causing the musical instrument to perform a predetermined operation.

### SUMMARY

According to an aspect of the present disclosure, there is provided a pedal device including a pedal case including an opening portion, a base member on which the pedal case is provided, a pedal projecting outwards of the pedal case via the opening portion and provided rotatably by a rotational shaft supported by a bearing portion provided on the base member, and a pedal leg portion provided on the base member, including a setting member provided in such a manner as to be brought into abutment with a setting surface, and projecting outwards of the pedal case on a side where the pedal projects.

### BRIEF DESCRIPTION OF THE DRAWINGS

FIG. 1 is a perspective view of an electronic keyboard instrument including a pedal device according to an embodiment of the present disclosure, as viewed obliquely downwards from a front upper position;

FIG. 2 is a perspective of the electronic keyboard instrument including the pedal device according to the embodiment of the present disclosure, as viewed obliquely upwards from a rear lower position;

FIG. 3 is a plan view of the pedal device according to the embodiment of the present, as viewed from below;

FIG. 4 is a partially sectional perspective of the pedal device according to the embodiment of the present disclosure in which, a pedal case is shown partially cross-sectioned;

FIG. 5 is a perspective view of the pedal device according to the embodiment of the present disclosure with the pedal case and a front sheet metal member omitted from illustration;

FIG. 6 is a sectional view of the pedal device according to the embodiment of the present disclosure taken along a line VI-VI in FIG. 3, with an upper side oriented upwards; and

FIG. 7 is a sectional view of the pedal device according to the embodiment of the present disclosure taken along a line VII-VII in FIG. 6.

### DESCRIPTION OF THE EMBODIMENT

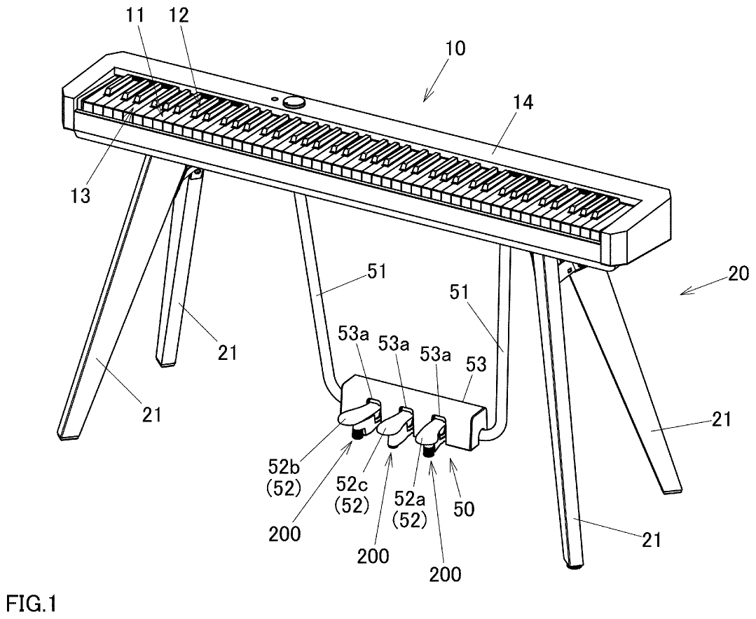

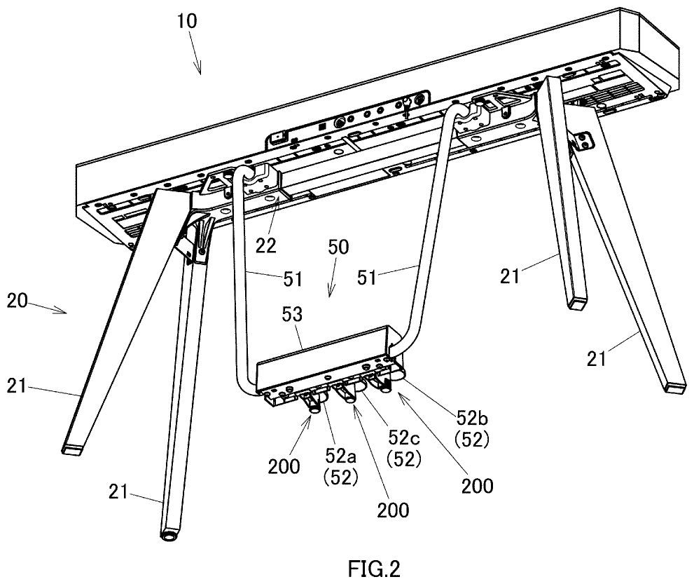

Hereinafter, an embodiment of the present disclosure will be described based on drawings. An electronic keyboard instrument 10 shown in FIGS. 1 and 2 includes an instrument case 14 including a base plate, a speaker, and the like which are provided in an interior thereof. The instrument case 14 further includes therein a full-scale (88-note) keyboard 13 including plural white keys 11 and plural black keys 12. The instrument case 14 (the electronic keyboard instrument 10) is supported by a leg portion 20. The leg portion 20 has a central support member 22, which is disposed on a lower surface of the instrument case 14 and is elongated in a left-right direction, and four legs 21, which are connected to the central support member 22. In the following description, a nearer side of the keyboard 13 is referred to as a front side, and an opposite side to the nearer side is referred to as a rear side. When facing the keyboard 13, a left side is referred to as left or a left side, and a right side is referred to as right or a right side. A side of the keyboard 13 facing upwards is referred to as upper or an upper side, and a side of the keyboard 13 facing the leg portion 20 is referred to as lower or a lower side.

Connecting rods 51 (connecting members), that is, a left connecting rod 51 and a right connecting rod 51 are connected to the central support member 22 of the leg portion 20. Each connecting rod 51 is connected to a rear surface of the central support member 22 at an upper end portion while extending downwards therefrom. The left and right connecting rods 51 are connected individually to a left side and a right side of a pedal device 50, respectively. That is, the pedal device 50 includes the connecting rods 51 which are the connecting members which connect with the leg portion 20 (the legs 21) for supporting the electronic keyboard instrument 10 as an attachment target thereof. The leg portion 20 and the connecting rods 51 may be connected indirectly to each other via another member such as the central support member 22 as in the case of the present embodiment or may be connected directly to each other.

The pedal device 50 includes a pedal case 53 which covers a base plate 161, sensor units 160, bearing portions 153, and the like (which will be described later). The pedal case 53 is formed substantially into a rectangular parallelepiped box elongated in the left-right direction and including a front and rear surfaces, an upper surface, and a left and right surfaces. Thus, the pedal case 53 is opened in a lower surface side. The pedal case 53 includes three opening portions 53a formed therein.

The pedal device 50 provided on the electronic keyboard instrument 10 also includes three pedals 52 which are aligned in a row to be positioned on a left side, a right side, and at a center (a right pedal 52a, a left pedal 52b, a center pedal 52c). Each pedal 52 projects forwards (outwards) via the corresponding opening portion 52a in the pedal case 53 and is provided rotatably. A pedal leg portion 200 is disposed below each pedal 52.

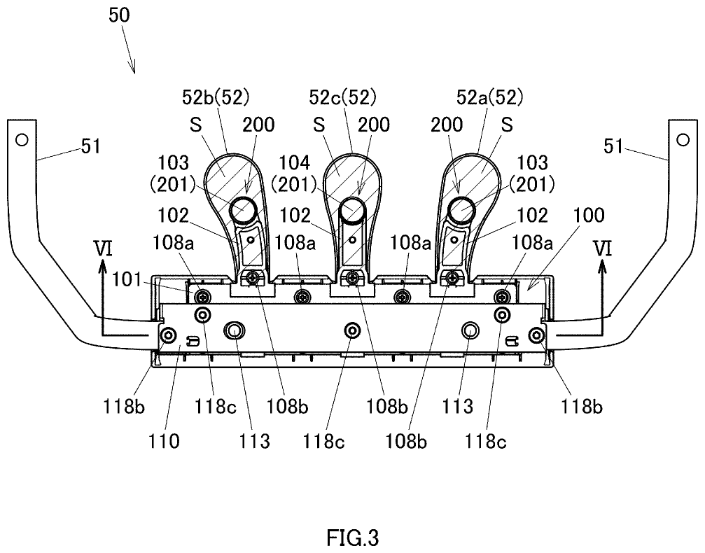

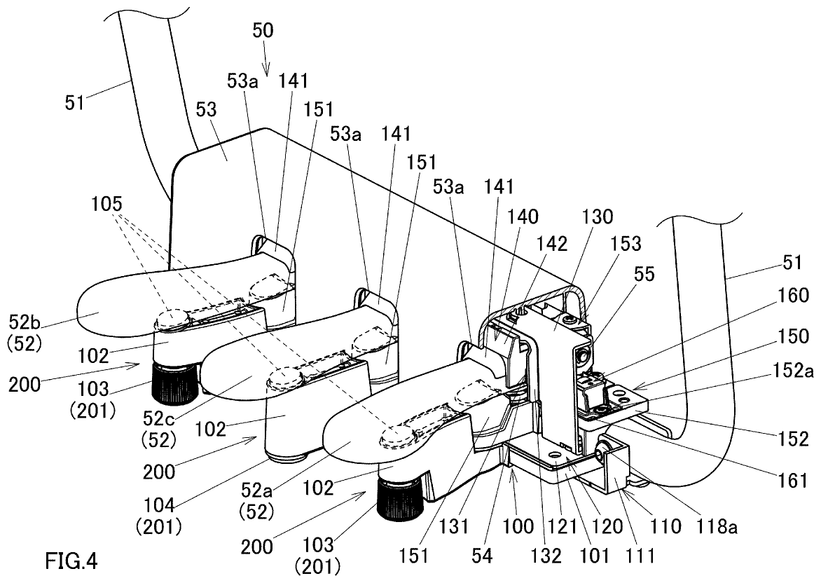

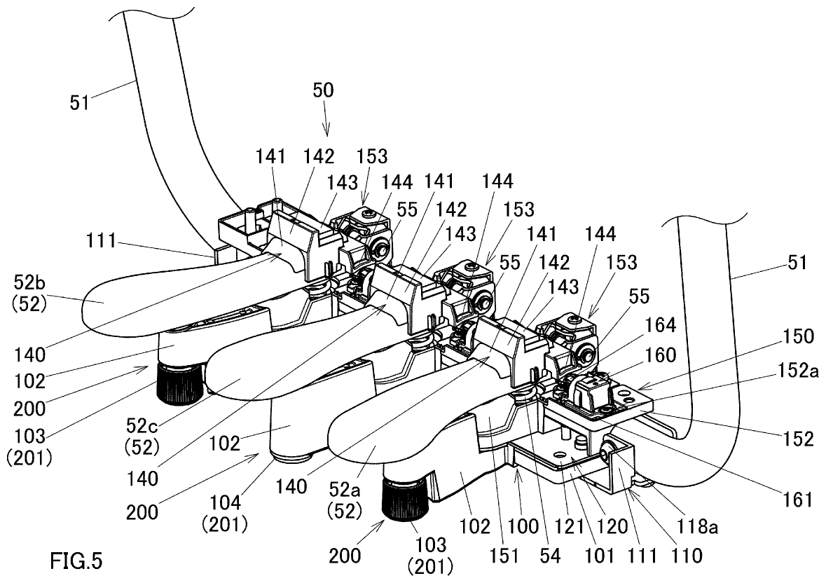

As shown in FIG. 3 (also, refer to FIGS. 4 and 5), the pedal leg portion 200 includes a pedal facing portion 102 and a setting member 201. Here, the pedal device 50 includes a lower base member 100 provided on a lower side thereof. The lower base member 100 includes a lower base member main body portion 101, which is elongated in the left-right direction and has a flat plate shape. Each pedal facing portion 102 is provided for each pedal 52 in such a manner as to extend forwards from the lower base member main body portion 101. In other words, the pedal leg portion 200 projects outwards of the pedal case 53 on a side where the corresponding pedal 52 projects forwards.

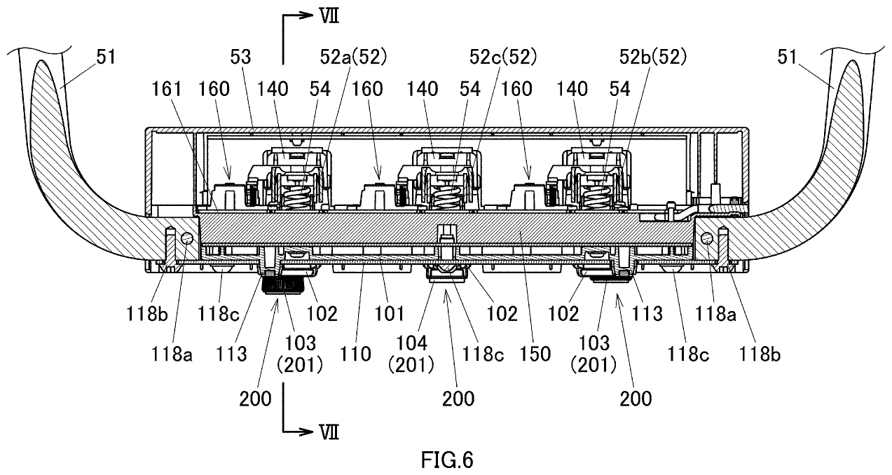

The setting member 201 of the pedal leg portion 200 constitutes a member which is provided to face a setting surface so as to be set on or lie close to the setting surface. Adjustment members 103, which function as adjustable setting members 201, are provided individually on pedal facing portions 102 which correspond to the right pedal 52a and the left pedal member 52b. The adjustment members 103 are configured to move in a vertical direction so as to be brought into abutment with the setting surface by operation of a screw construction for adjustment. FIG. 6 shows a state in which the adjustment member 103 corresponding to the right pedal 52a is moved downwards. On the other hand, a pad 104 is provided on the pedal facing portion 102 which corresponds to the center pedal 52c as a setting member 201 which is fixed to the pedal facing portion 102. In this way, the setting members 201 include the adjustment members 103, and the adjustment members 103 are provided in such a manner as to correspond to the outer pedals 52 (the right pedal 52a and the left pedal 52b) in the three pedals 52.

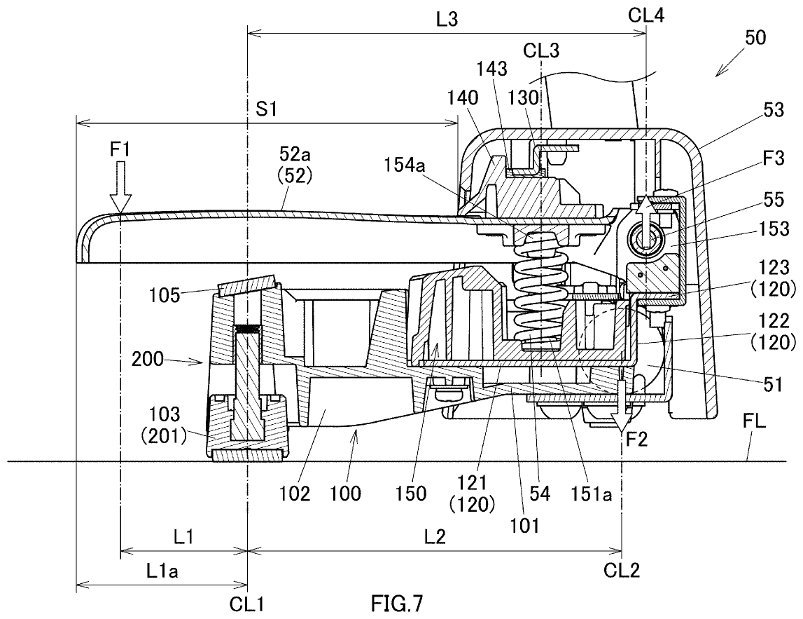

As shown in FIG. 3, each pedal leg portion 200 (the pedal facing portion 102 and the setting member 201 (the adjustment member 103, the pad 104) which are positioned outside the pedal case 53) is disposed within a projected area S (a portion shaded with oblique lines in FIG. 3) on an exposed portion of each pedal 52. Here, the exposed portion of the pedal 52 means a portion occupied by the pedal 52 in a portion where the pedal 52 projects further outwards than the opening portion 53a in the pedal case 53 (a portion having a dimension S1 defined from an external surface of the pedal case 53 to a distal end of the pedal 52 in FIG. 7).

As shown in FIG. 4, a cushion member 105 is provided on the pedal facing portion 102 of each pedal leg portion 200 in such a manner as to face a lower surface of each pedal 52. For example, a felt material can be used for the cushion member 105. The cushion member 105 functions as a lower limit restricting member for restricting a lower limit of the pedal 52. That is, the cushion member 105 is brought into abutment with the lower surface of the pedal 52 to restrict a lower limit position of the pedal 52. The cushion member 105 is disposed on an axis center (for example, on an axis center CL1 shown in FIG. 7) of the setting member 201 (the adjustment member 103, the pad 104).

As shown in FIGS. 4 and 5, an upper sheet metal member 120 is provided on an upper surface of the lower base member main body portion 101 of the lower base member 100. As shown in FIG. 7, the upper sheet metal member 120 includes a lower plate portion 121, which is disposed on the lower base member main body portion 101 into a flat plate, an upper plate portion 123 of a flat plate shape, and a connecting plate 122, which is provided upright in a vertical direction so as to connect the lower plate portion 121 and the upper plate portion 123 together.

As shown in FIG. 4, the pedal device 50 includes a front sheet metal member 130 provided in such a manner as to rise upright from an upper surface of the lower plate portion 121 of the upper sheet metal member 120 with upper and lower longitudinal end portions bent rearwards. The front sheet metal member 130 is fixed to the lower plate portion 121, the lower base member main body portion 101, and a plate on a lower surface side of a lower sheet metal member 110, which will be described later, as a result of a lower plate portion, that is, the lower longitudinal end portion bent rearwards being fastened together therewith with screw members 118c (refer to FIG. 3). An upper plate portion of the front sheet metal member 130, that is, the upper longitudinal end portion bent rearwards is fixed to a lower surface of an upper plate portion of the pedal case 53 (refer to FIG. 7). The front sheet metal member 130 includes opening portions 131 formed therein in such a manner as to correspond individually to the pedals 52. The opening portions 131 are each configured to be opened in a lower side thereof. A rib 132 is provided around a circumferential edge portion of each opening portion 131. In FIG. 4, only the opening portion 131 (the rib 132) is shown which corresponds to the right pedal 52a.

As shown in FIGS. 4 and 5, a restricting member 140 is fixedly provided on an upper surface of a proximal end portion side of each of the pedals 52 with a screw member (not shown). The restricting member 140 includes a first restricting portion 141 and a second restricting portion 142. The first restricting portion 141 includes an inclined surface which inclines towards a proximal end portion side of the pedal 52 in such a manner as to cover an upper surface of the relevant pedal 52. The second restricting portion 142 includes an inclined surface which connects to an upper portion of the first restricting portion 141 and inclines towards the proximal end portion side of the pedal 52 with this restricting member 140. A finger or the like is restricted from entering a space defined between the pedal 52 and the corresponding opening portion 53a.

As shown in FIG. 5, a cushion member 143 is provided on an upper surface of the restricting member 140 behind the inclined surface of the second restricting portion 142. For example, a felt material can be used for the cushion member 143. The cushion member 143 is brought into abutment with an upper side portion of the opening portion 131 (the rib 132) in the front sheet metal member 130 to thereby restrict an upper position of the pedal 52. The restricting member 140 includes an arm portion 144 which projects towards the sensor unit 160, which will be described later, so as to be brought into engagement with a cam member 164 of the sensor unit 160.

An upper base member 150 is provided above the lower base member 100 via the upper sheet metal member 120. The upper base member 150 includes spring holding portions 151 which are provided individually on respective proximal end portions of the pedal facing portions 102 of the lower base member 100. The spring holding portion 151 has a cylindrical shape and includes a coil spring 54 disposed in an interior thereof. As shown in FIG. 7, a lower spring support shaft 151a is provided on a base of the spring holding portion 151 to thereby support a lower end of the coil spring 54. An upper end of the coil spring 54 is supported by an upper spring support shaft 154a of a spring receiving member 154 which is provided on a lower surface of the pedal 52. The pedal 52 is biased upwards by the coil spring 54.

As shown in FIGS. 4 and 5, a proximal end portion of each spring holding portion 151 on the upper base member 150 connects with an upper base member main body portion 152. The upper base member main body portion 152 is provided into a plate which is elongated in the left-right direction. Bearing portions 153 are provided on an upper surface of the upper base member main body portion 152 so as to individually support rotational shafts 55 (also, referred to as rotating shafts) rotatably which are provided individually at the respective proximal end portions of the pedals 52. The upper surface of the upper base member main body portion 152 is made into a recessed portion 152a which is elongated in the left-right direction. The base plate 161 is provided in the recessed portion 152a. The sensor units 160 are provided on an upper surface of the base plate 161. The sensor unit 160 is configured to detect a depressing amount of the pedal 52 as a result of the cam member 164 being brought into abutment with a cam surface of the arm portion 144 of the restricting member 140.

As shown in FIGS. 3 to 5, the lower sheet metal member 110 having an L-shaped cross section (refer to FIG. 7) is provided on a lower surface of the lower base member main body portion 101 of the lower base member 100. The lower sheet metal member 110 includes, as shown in FIGS. 4 and 5, fixing portions 111 which are provided individually at left and right end portions thereof in such a manner as to rise upright therefrom substantially into an L shape in a plan view. The left and right fixing portions 111 are fixed individually to front surfaces of end portions of the left and right connecting rods 51, respectively, with a screw member 118a. As shown in FIGS. 3 and 6, a lower surface of the lower sheet metal member 110 and the left and right connecting rods 51 are fixed together with screw members 118b. Then, as shown in FIG. 6, the lower end portions of the left and right connecting rods 51 are disposed so close to left and right side surfaces of the upper base member 150 as to be brought into abutment therewith. In this way, the connecting rods 51, which are the connecting members, are fixed to a base member of the pedal device 50 which includes the lower sheet metal member 110.

Here, the base member of the pedal device 50 includes the lower base member 100 and the lower sheet metal member 110 which are made integral with the screw members 118c and the upper base member 150 which is fixed to the lower base member 100.

In addition, as shown in FIGS. 3 and 6, a pad 113 is provided at two left and right locations on the lower surface of the lower sheet metal member 110, and this pad 113 functions as a cushion for softening the effect of an impact produced when the electronic keyboard instrument 10 or the pedal device 50 is set on the setting surface. Screw members 108a provided on the lower base member main body portion 101 shown in FIG. 3 are a part of the screw members for fixing the lower base main body portion 101 and the pedal case 53 together via the lower plate portion 121 of the upper sheet metal member 120. Screw members 108b which are provided in such a manner as to correspond to the pedal facing portions 102 are screw members for fixedly connecting the lower base member 100 and the upper base member 150 together.

Here, as shown in FIG. 7, the pedal device 50 is used by bringing the adjustment members 103 into abutment with a setting floor surface FL. As a result, a force F1 with which the pedal 52 (the right pedal 52a in FIG. 7) is depressed is borne by the setting floor surface FL by way of the cushion member 105 which is brought into abutment with the lower surface of the pedal 52 and the adjustment member 103. A distance L1a from an axis center CL1 of the adjustment member 103 to a distal end of the pedal 52 is smaller than a distance L2 from the axis center CL1 of the adjustment member 103 to an axis center CL2 of the connecting rod 51 (L1a<L2). That is, since a distance L1 from a position where to depress the pedal 52 (a position to which the force F1 is applied) to the axis center CL1 of the adjustment member 103 is set smaller than the distance L1a (L1<L1a), the distance L1 is smaller than the distance L2 (L1<L2). In addition, a part (a force F2) of the load of the electronic keyboard instrument 10 is applied to the connecting rod 51 because the adjustment member 103 is set on the setting floor surface FL.

With the pedal device 51, a relationship expressed by an expression (1) is set for a moment around the axis center CL1 of the adjustment member 103 due to the distance L1 being set sufficiently shorter than the distance L2.

Distance L1×Force F1<Distance L2×Force F2 (1)

With the pedal 52, based on the principle of leverage, letting the position of the force F1 be a point of effort, the axis center CL of the adjustment member 103 be a fulcrum, and the rotational shaft 55 be a point of action (a force applied to the rotational shaft 55 be F3), then, an expression (2) is established as below:

Distance L1×Force F1=Distance L3×Force F3 (2)

Then, from the expression (1) and the expression (2), an expression (3) is given as below:

Distance L3×Force F3<Distance L2×Force F2 (3)

That is, the pedal device 50 is set so that even when the pedal 52 is depressed, the rear legs 21 are prevented from moving apart from the setting floor surface FL, which would otherwise be caused as a result of the rear of the electronic keyboard instrument 10 being lifted up via the connecting rods 51 with the upward force F3 applied to the rotational shaft 55 of the pedal 52. Thus, although the description is made heretofore only on the right pedal 52a, the same can be true with the left pedal 52b and the center pedal 52c. In particular, as to the center pedal 52c, the same can naturally be said in the case that the pad 104, which is the setting member 201 for the center pedal 52c, is in abutment with the setting floor surface FL. However, even in the case that the pad 104 is not in abutment with the setting floor surface FL, as long as the left and right adjustment members 103 are in abutment with the setting floor surface FL, as has been described heretofore, the risk is reduced that the rear legs 21 are caused to move apart from the setting floor surface FL when the center peal 52c is depressed.

In addition, in relation to its position in a front-rear direction, the axis center CL2 of the connecting rod 51 is disposed between a center axis CL3 of the coil spring 54 as a biasing member for biasing the pedal 52 upwards and an axis center CL4 of the rotational shaft 55. As a result, in the front-rear direction, a distance between the downward force (load) F2 and the upward force F3 and a distance between the downward force (load) F2 and the biasing force applied by the coil spring 54 are both set small.

Thus, according to the embodiment of the present disclosure, the pedal device 50 has the pedal case 53 including the opening portions 53a, the base member (the lower base member 100, the upper base member 150, and the like) on which the pedal case 53 is provided, the pedals 52 which project outwards of the pedal case 53 through the corresponding opening portions 53a and which are provided rotatably by the rotational shafts 55 as the rotational shafts supported by the corresponding bearing portions 153 provided on the upper base member 150 of the base member, and the pedal leg portions 200 which are provided on the lower base member 100 of the base member, which include individually the setting members 201 provided in such a manner as to be brought into abutment with the setting floor surface FL, and which project outwards of the pedal case 53 on the side where the pedals 52 project.

As a result, since each setting member 201 is disposed in the vicinity of the position where the pedal 52 is depressed (the position denoted as F1 in FIG. 7), the risk is reduced that the rear legs 21 are caused to move apart from the setting floor surface FL by depression of the pedal 52. Consequently, a risk can be reduced that the electronic keyboard instrument 10 is caused to move while it is being played.

In the base member including the lower base member 100 and the upper base member 150, the bearing portions 153 are provided on the upper base member 150, and the setting members 201 are provided on the lower base member 100. As a result, the base member including the setting members 201 and the bearing portions 153 can be provided compact into a single integral unit by providing the setting members 201 under the pedals 52.

The setting member 201 (the adjustment member 103, the pad 104) is disposed within the projected area S of the pedal 52. Further, the pedal leg portion 200 is also disposed within the projected area S. As a result, when the pedal device 50 is seen from above along the line of sight of the player who is playing the electronic keyboard instrument 10, the pedal leg portion 200 and the setting member 201 become invisible, and the pedal leg portion 200 and the setting member 201 become visible only when the player sits down by the pedal device 50 to look at it closely. Thus, the pedal device 50 can be provided which provides for a good external appearance. In addition, the adjustment member 103 of the setting member 201 includes the screw construction for adjustment, and hence, the adjustment member 103 in particular is preferably positioned within the projected area S. In other words, although the pedal leg portion 200 can be disposed outside the projected area S only with the setting member 201 disposed within the projected area S, the pedal leg portion 200 is also preferably disposed within the projected area S from an aesthetic point of view.

The connecting rods 51, which are the connecting members connecting to the leg portion 20 (the legs 21) for supporting the electronic keyboard instrument 10 which is the attachment target of the pedal device 50, are fixed to the base member (the lower base member 100 and the lower sheet metal member 110). The distance L1a from the axis center CL1 of the setting member 201 to the distal end of the pedal 52 is smaller than the distance L2 from the axis center CL1 of the setting member 201 (the adjustment member 103, the pad 104) to the axis center CL2 of the connecting rod 51.

As a result, the position where to depress the pedal 52 (the position denoted by F1 in FIG. 7) can be disposed in the vicinity of the setting member 201 in the front-rear direction. Then, with the right pedal 52a and the left pedal 52b, the adjustment member 103 can be disposed in a position lying directly below the position to depress the pedal 52. As a result, the depressing force F1 can be borne directly by the setting member 201.

In addition, the pedal device 50 has the coil springs 54 for biasing the corresponding pedals 52 upwards. The axis center CL2 of the connecting rod 51 is disposed between the axis center CL3 of the coil spring 54 and the axis center CL4 of the rotational shaft 55. As a result, the axis center CL2 of the connecting rod 51 to which the force F2, which is the part of the load of the electronic keyboard instrument 10, is applied can be disposed near the coil spring 54 and the rotational shaft 55, whereby the biasing force of the coil spring 54 and the force F3 applied to the rotational shaft 55 can be cancelled by the force F2 without generating as much moment as possible.

The pedal leg portion 200 includes the cushion member 105, which functions as the lower limit restricting member for restricting the lower limit of the pedal 52, provided on the axis center CL1 of the setting member 201 (the adjustment member 103, the pad 104) which faces the lower surface of the pedal 52. As a result, the depressing force F1 with which the pedal 52 is depressed can be borne by the pedal leg portion 200 (the setting member (201) without generating as much moment as possible.

The adjustment member 103 of the setting member 201 is configured to move in the vertical direction by the screw construction. As a result, the pedal device 50 can be set on the setting floor surface FL in an ensured fashion with the simple configuration.

In addition, the pedal device 50 includes the three pedals 52 (the right pedal 52a, the left pedal 52b, the center pedal 52c), and the adjustment members 103 are provided individually on the right pedal 52a and the left pedal 52b which constitute the outer pedals 52 in the three pedals 52. As a result, the pedal device 50 can be set on the setting floor surface FL with a good balance in the left-right direction.

The electronic keyboard instrument 10 includes the pedal device 50. As a result, the electronic keyboard instrument 10 can be provided which includes the pedal device 50 which can reduce the risk that the electronic keyboard instrument 10, which is the attachment target of the pedal device 50, is caused to move while it is being played even when the pedals 52 of the pedal device 50 are depressed and which can provide for the good external appearance by making the pedal leg portions 200 (the setting members 201) hardly visible by concealing them under the pedals 52. In the present embodiment, while the pedal device 50 is described as being provided on the electronic keyboard instrument 10, the pedal device 50 can also be provided on other musical instruments and electronic musical instruments.

While the embodiment of the present invention has been described heretofore, the embodiment is presented as the example, and hence, there is no intention to limit the scope of the present invention by the embodiment. The novel embodiment can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. A pedal device comprising:
a pedal case comprising an opening portion;
a base member on which the pedal case is provided;
a pedal projecting outwards of the pedal case via the opening portion and provided rotatably by a rotational shaft supported by a bearing portion provided on the base member; and
a pedal leg portion provided on the base member, comprising a setting member provided in such a manner as to be brought into abutment with a setting surface, and projecting outwards of the pedal case on a side where the pedal projects.

2. The pedal device according to claim 1,
wherein the base member comprises a lower base member and an upper base member provided above the lower base member,
wherein the bearing portion is provided on the upper base member, and
wherein the setting member is provided on the lower base member.

3. The pedal device according to claim 1,
wherein the setting member is disposed within a projected area of the pedal.

4. The pedal device according to claim 1,
wherein the setting member is disposed within a projected area of a part of the pedal which projects from the opening portion.

5. The pedal device according to claim 1,
wherein a connecting member is fixed to the base member, the connecting member being configured to connect with a leg portion configured to support an attachment target.

6. The pedal device according to claim 5,
wherein a distance from an axis center of the setting member to a distal end of the pedal is smaller than a distance from the axis center of the setting member to an axis center of the connecting member.

7. The pedal device according to claim 5, comprising:
a biasing member configured to bias the pedal upwards,
wherein an axis center of the connecting member is disposed between an axis center of the biasing member and an axis center of the rotational shaft.

8. The pedal device according to claim 1,
wherein the pedal leg portion includes a lower limit restricting member provided on an axis center of the setting member which faces a lower surface of the pedal, the lower limit restricting member being configured to restrict a lower limit of the pedal.

9. The pedal device according to claim 1,
wherein the setting member comprises an adjustment member configured to move in a vertical direction through an operation of a screw construction.

10. The pedal device according to claim 9,
wherein the pedal is provided three in a row, and
wherein the adjustment member is provided for each of outer pedals in the three pedals so provided.

11. The pedal device according to claim 2,
wherein a lower sheet metal member of a substantially L-shaped cross section is provided on a lower surface of a lower base member main body portion of the lower base member.

12. The pedal device according to claim 2,
wherein a pad configured to be brought into abutment with a setting surface is provided on a lower surface of the lower sheet metal member.

13. An electronic keyboard instrument comprising the pedal device according to claim 1.

14. An electronic keyboard instrument comprising the pedal device according to claim 5.

15. An electronic keyboard instrument comprising the pedal device according to claim 6.
